(19) United States
(12) Patent Application Publication
(10) Pub. No.: US 2024/0201982 A1
(43) Pub. Date: Jun. 20, 2024

(54) SOFTWARE APPLICATION MODERNIZATION ANALYSIS

(71) Applicant: INTERNATIONAL BUSINESS MACHINES CORPORATION, ARMONK, NY (US)

(72) Inventors: Shailendra Moyal, Pune (IN); Sarbajit K. Rakshit, Kolkata (IN); Partho Ghosh, Kolkata (IN)

(21) Appl. No.: 18/065,719

(22) Filed: Dec. 14, 2022

(51) Int. Cl. G06F 8/72; G06F 8/77

(52) U.S. Cl. CPC G06F 8/72; G06F 8/77

(57) ABSTRACT

A software application may be analyzed to determine how the software application has performed across numerous dimensions using historical data regarding the software application. This analysis may be for a specific organization. The performance of the software application may be compared to a plurality of modernization options. A modernization option that is determined to perform better than the software application in at least one of the numerous dimensions is identified. A total cost for the organization to realizing the modernization option is calculated. The calculation includes a simulation of personnel of the organization providing services of the organization while integrating the modernization option among a suite of software applications.

### BACKGROUND

Software solutions have to undergo modernization on a regular schedule. For example, modernization may include replacing a current software application with an updated version of that same software application, or with a different software application, or requesting/programming a patch to the software application, or the like. Once you determine that a new modernization option is desired, it may be a cumbersome exercise to get that modernization option realized. For example, realizing a modernization option may include devoting programmers to develop patches, devoting integration engineers to integrate a patch into a current solution, determining when applications may be brought offline to patch them (e.g., where the applications are software-as-a-service (SaaS) applications), devoting support staff to assist clients as they learn about a new edition of the applications, or the like. Each of these considerations may be nebulous to identify and quantify.

### SUMMARY

Aspects of the present disclosure relate to a method, system, and computer program product relating to analyzing modernization options of software applications. For example, the method includes analyzing how a software application has performed across numerous dimensions using historical data regarding the software application for an organization. The method further includes comparing the performance of the software application to a plurality of modernization options. The method further includes identifying a modernization option that is determined to perform better than the software application in at least one of the numerous dimensions. The method further includes calculating a total cost to the organization for realizing the modernization option by a simulation of personnel of the organization providing services of the organization while integrating the modernization option among a suite of software applications. A system and computer program configured to execute the method described above are also described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example environment in which a computing controller may analyze modernization options for software solutions.

FIG. 2 depicts an example flowchart by which the controller of FIG. 1 may analyze modernization options for software solutions.

FIG. 3 depicts a conceptual box diagram of a computing system that may host and/or include the controller of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to software application modernization analysis, while more particular aspects of the present disclosure relate to using artificial intelligence (AI) to comprehensively analyze how a software application may be modernized and simulating what it would take to realize that modernization in order to analyze and decide how to manage a set of software applications, potentially automating some/many/all of these steps (including automating the step of modernizing the software application). While the present disclosure is not necessarily limited to such applications, various aspects of the disclosure may be appreciated through a discussion of various examples using this context.

Modern organizations typically utilize a great number of software applications to conduct their enterprise. These software applications may include back-end applications to support the enterprise, front-end applications that are sold in some form to the clients, support applications that enable the organization to interface with their clients as the organization provides/sells other services/products, or the like. Once applications are deployed, then the organization typically needs a maintenance and support team while the application is running. In some instances, this support/maintenance team may include members of the organization, though in other instances an organization may outsource this support/maintenance.

As such, while each application is in use there is a cost associated with this application. This cost includes items such as maintenance and support costs, cloud computing support costs, business impacts from the application not operating as expected, or the like. Different applications have different level of priority, and for different contextual scenarios different applications might be assigned different levels of importance by the organization. For example, an application that is used to manage an organization-wide vacation schedule may receive moderate priority, while an application that does the accounting for the organization may receive the highest priority. As such, it may be difficult (if not impossible) for some conventional software support tools to determine when and how to modernize an application as necessary while correctly factoring for all of these costs, priorities, personnel abilities, or the like.

Aspects of this disclosure solve or address these concerns. For example, aspects of this disclosure may relate to an AI-enabled system that is configured to selectively identify candidate applications (or modules of the applications) that warrant modernization, and to further analyze whether and how to modernize based on these considerations. One or more computing devices that include one or more processing units executing instructions stored on one or more memories may provide the functionality that addresses these problems, where said computing device(s) are herein referred to as a controller (though this functionality may be spread into numerous devices in different instances).

Specifically, the controller may consider and weigh numerous data points in evaluating a software modernization. For example, the controller may gather and/or determine the historical usage pattern of various applications, the business importance of the applications, a technology gap between available recent technology and the current technology of the application, an availability of technical personnel to support the applications, a health of the applications (e.g., a number of bugs, a difficulty in fixing these bugs, a number of employees that have the expertise to fix these bugs, other performance metrics of the application), a potential business impact if the applications are not able to provide data/services on time, or the like. The controller may identify the applications or modules of the applications that are “due” for modernization and balance this against which modernizations are easier/cheaper/relatively more required/etc. so that applications can be modernized in a way that intelligently accounts for the “cost” of modernization in a comprehensive manner.

The controller may predict a technology lifecycle, including predicting possible future release timelines of relevant upcoming technology that correspond to the software applications, and accordingly identify when the modernization of any application should be scheduled (and/or schedule when this new application functionality may likewise be due for replacement). Based on the analysis of the controller, the controller may also further be configured to automate some or all of the process of realizing this modernization (e.g., buying the new software, scheduling personnel to train and support it, etc.).

The controller may gather data from numerous sources to conduct this analysis. For example, the controller may consider functionalities of the current application, various meetings on this functionality (e.g., whether from sensors that capture real-time natural language content of this meeting that the controller may analyze, or whether from stored documents that record relevant content of the meetings), email communication related to the application such as requirements of the applications, or the like. With this gathered information, the controller may identify functional and non-functional requirements so that during modernization of the application, the updated software solution can accommodate the newly identified requirements.

Beyond this, the controller may simulate how some or all of these factors may play out over time for the organization, where this simulation accounts for application usage patterns, importance of the assorted applications, current health of the applications, and the like. Based on this simulation, the controller may identify a preferred modernization plan, where this modernization plan includes a sequence of modernization(s) for the entire application suite of the organization so that aggregated cost of ownership can be optimized (e.g., where an optimized cost includes the monetary price being low, the disruption to the organization being minimized, organization employees having reasonable workloads, and the like). Further, as discussed herein, in some instances the controller may autonomously execute some or all of the steps of the modernization plan (e.g., autonomously purchasing, downloading, or installing some software functionality, and/or scheduling some human resources to support this software functionality accordingly).

The controller may select a modernization plan to go with based on application usage patterns (or application module usage patterns, where only a single portion/module of an application is to be modernized), detected changes in business process, and/or predicted changes in business process. In some instances, the controller may determine that some or all applications and/or application modules do not currently need any modernization (whether because they are performing acceptably or whether because there is no modernization which is available for an acceptable cost). In some examples, the controller may determine that both the performance of an application is poor and also modernization is not currently practicable (e.g., as a result of current modernization costing too much), in response to which controller may recommend and/or autonomously act to disable this application.

In this way, the controller may propose application modernization techniques based on real-time communication, network needs, scalability, and the like. Further, the controller may do so in a way that provides an outline of the overall modernization needs of the suite of applications of the organization. The controller may identify the needed technical and non-technical dependencies of this modernization plan based on any detected/predicted changes of business processes and/or governance.

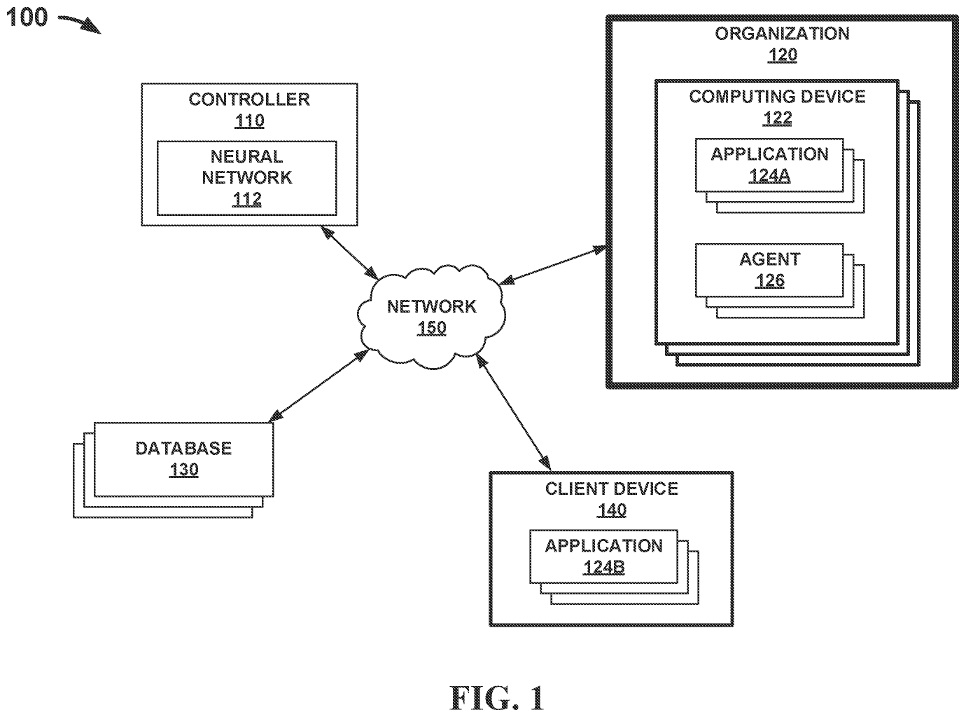

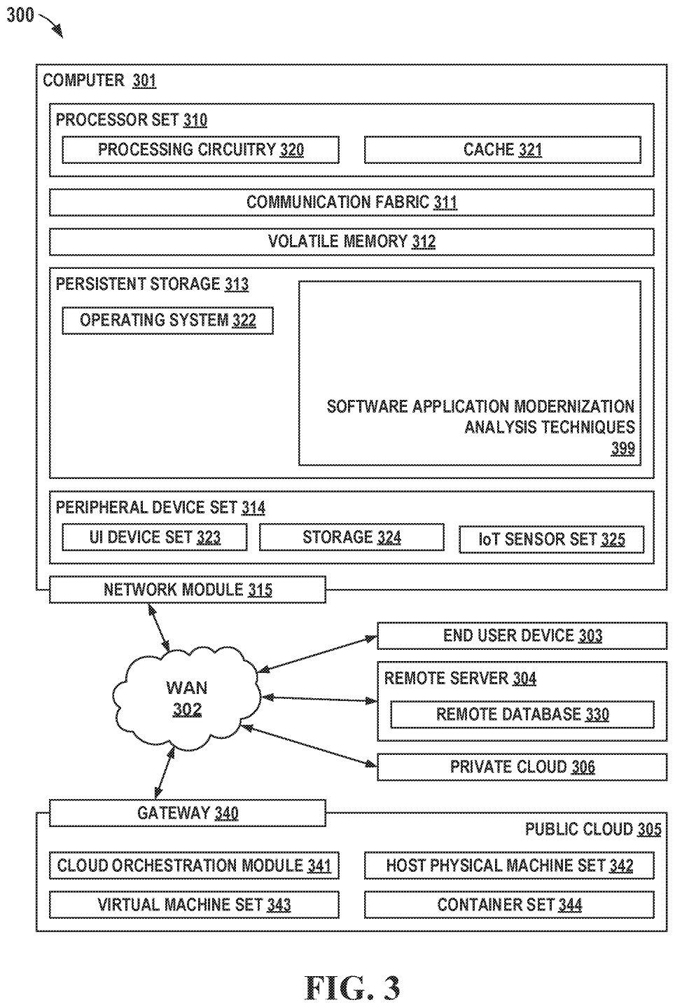

For example, FIG. 1 depicts environment 100 in which controller 110 may analyze modernization options for organization 120. Controller 110 may include a processor coupled to a memory (as depicted in FIG. 3) that stores instructions that cause controller 110 to execute the operations discussed herein. Though controller 110 is depicted as being structurally distinct from computing devices 122 and historical databases 130, in some embodiments controller 110 may share some computing components with computing devices 122 and/or historical databases 130.

Controller 110 may use neural network 112 or the like to analyze applications 124A, 124B (collectively or generically referred to herein as “applications 124”), whether these applications 124 are used/hosted/accessed on computing device 122 of organization 120 or on remote client devices 140 (e.g., where remote client devices 140 are computers similar to what is depicted in FIG. 3 that are used by people that are clients of organization 120). Controller 110 may gather the data described herein using agents 126, and/or controller 110 may access data from one or more databases 130 that store data related to applications 124 and/or modernization options as discussed herein.

Controller 110 may interact with computing devices 122, client devices 140, and/or historical databases 130 using network 150. Network 150 may include a computing network over which computing messages may be sent and/or received. For example, network 150 may include the Internet, a local area network (LAN), a wide area network (WAN), a wireless network such as a wireless LAN (WLAN), or the like. Network 150 may comprise copper transmission cables, optical transmission fibers, wireless transmission, routers, firewalls, switches, gateway computers and/or edge servers. A network adapter card or network interface in each computing/processing device (e.g., computing devices that host/include computing device 122, client device 140, and/or historical databases 130) may receive messages and/or instructions from and/or through network 150 and forward the messages and/or instructions for storage or execution or the like to a respective memory or processor of the respective computing/processing device. Though network 150 is depicted as a single entity in FIG. 1 for purposes of illustration, in other examples network 150 may include a plurality of private and/or public networks.

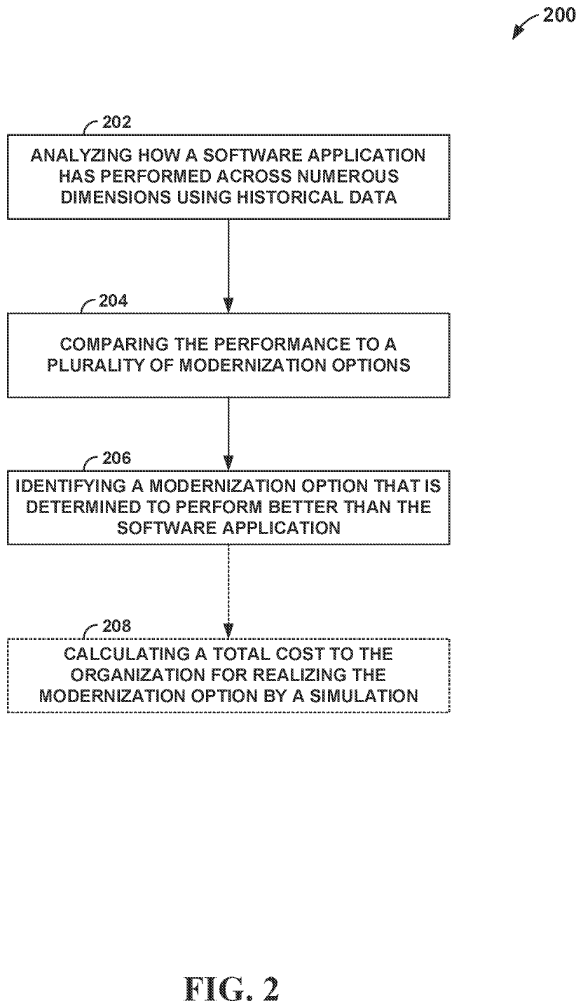

Controller 110 may manage software application modernization according to flowchart 200 depicted in FIG. 2. Flowchart 200 of FIG. 2 is discussed with relation to FIG. 1 for purposes of illustration, though it is to be understood that other environments with other components may be used to execute flowchart 200 of FIG. 2 in other examples. Further, in some examples controller 110 may execute a different method than flowchart 200 of FIG. 2, or controller 110 may execute a similar method with more or less steps in a different order, or the like.

Controller 110 analyzes how one or more software applications 124 have performed for organization 120 (202). In some examples, controller 110 may analyze applications 124A that are used/accessed primarily on computing devices 122 of organization, but in certain examples controller 110 may alternatively or additionally gather data regarding a performance of applications 124B that are used/access primarily on client devices (e.g., where software application 124B is paid for by a user of client device and organization 120 provides/supports this software application 124B).

Controller 110 may analyze software application 124 performance across numerous dimensions. For example, controller 110 may gather data from agents 126 on computing devices 122 of organization 120. Specifically, agents 126 may be configured to gather computer resource utilization data regarding software applications 124, such as how much memory is being used, how much processing power is being used, how much disk capacity is being used, or how much network bandwidth is being used by software applications 124. Agents 126 may also gather data directly from software applications 124 themselves, such as a gathering data regarding a responsiveness of software applications 124 (e.g., how long it takes for software applications 124 to process a request or load a new screen as requested by a user), an amount of errant clicks within software applications (e.g., an amount of times where a user clicks into a menu only to immediately exit out that menu), or the like.

In some examples, controller 110 may gather historical data from databases 130 to evaluate how software applications 124 have performed. Databases 130 may include data from agents 126. Databases 130 may further include information such as help desk tickets regarding software applications 124, complaints received regarding software applications 124, or the like. In some examples, controller 110 may have access to (and/or databases 130 may store) organization 120 communication stored on one or more platforms accessible to organization 120 (e.g., an email server, or a instant-messaging platform used by employees of organization 120), and controller 110 may query communication sent across organization 120 to analyze a performance of a software application 124. For example, controller 110 may use sentiment analysis to determine whether or not users are enjoying using software applications 124, and/or whether or not users have certain specific complaints that indicate a drop in performance of software applications 124.

In some examples, controller 110 may analyze software applications 124 in response to a prompt from a user. In other examples, controller 110 may analyze software applications 124 on a predetermined schedule (e.g., once a week, or once a month, or once a quarter). In some examples, controller 110 may determine and/or change such a predetermined schedule. For example, controller 110 may detect that an identified software application 124 is performing very well and/or that a cost of modernization is prohibitively high, in response to which controller 110 may schedule a next analysis of this identified software application 124 to be at some time in the relatively distant future (e.g., a period of time in which it is expected that either this identified software application 124 will begin to perform worse, and/or it is expected that the cost of modernization will drop to an acceptable amount). For some situations the distant future may be weeks off, whereas in other instances the distant future may be months or even years off. Alternatively, where a software application 124 is performing relatively poorly and/or the cost of modernization is relatively inexpensive, controller 110 may schedule another analysis relatively soon (if software application is not scheduled for modernization as a result of the analysis of controller), and/or controller 110 may schedule this software application 124 to be decommissioned. For example, if controller 110 detects that a software application 124 has a performance issue of a security flaw that opens up organization 120 to a security breach, and further controller 110 detects that no modernization exists that is below a cost threshold, controller 110 may autonomously decommission this software application 124, or recommend that software application 124 be decommissioned as soon as possible.

Controller 110 compares the performance of the software application 124 to a plurality of modernization options (204). Modernization options includes ways in which code of at least one portion of software applications 124 may be replaced with at least some new code. For example, a modernization option may include upgrading one module of software applications 124. This may include a situation where there is standalone functionality that may be added or replaced/upgraded while maintaining other portions of software applications 124 in a relatively unchanged state. In other examples, the modernization option may include upgrading the entire software application 124 with a new version of the same (or a different) software application.

In some examples, software applications 124 may be provided by an external party, such that upgrading some or all of the software application may include purchasing the same or a different software application. In other examples, software applications 124 may be created, maintained, customized, or the like by organization 120, such that programmers of organization 120 are responsible for providing the functionality of software application 124. Where software application 124 is provided by an external party, controller 110 may identify capabilities of other modernization options by crawling online repositories or the like in order to compare the performance of software applications 124 to the modernization options. Alternatively, where software applications are programmed/customized/maintained by organization 120, controller 110 may extrapolate new/improved capabilities of software applications 124 that may be possible, and compare the current performance of software applications 124 against these extrapolated capabilities.

Controller 110 identifies a modernization option that is determined to perform better than one of software applications 124 (206). Controller 110 may determine that this modernization option will perform better than software applications 124 across one or more dimensions that software application 124 performance was analyzed on (at 202). For example, controller 110 may determine if the modernization option will use less processing power, be more responsive, cause less crashes, and/or will result in less complaints/tickets from users.

Controller 110 calculates a total cost to the organization for realizing the modernization option (208). This total cost may include both a monetary amount and also a number of human-hours predicted/required to realize this modernization option, as well as potentially included other elements of cost if desired by a user (e.g., an amount of “goodwill” that may be required to change software applications 124, as sometimes people are resistant to even good change). Controller 110 may calculate the total cost by simulating the act of implementing the modernization option using a neural network 112. Specifically, controller 110 may cause neural network 112 to simulate personnel of organization 120 providing goods and services while integrating the modernization option among a suite of software applications 124. Controller 110 may gather real time information from computing agents 126 to simulate how organization 120 would provide their services.

Neural network 112 may simulate the entirety of the causal chain of realizing the modernization option in order to calculate the total cost of the modernization option. For example, controller 110 may cause neural network 112 to simulate how many people will be required to work to set up the modernization option, train people on the modernization option, answer questions on the modernization option, or the like. Neural network 112 may simulate some people leaving organization 120 as a result of getting the modernization option, some people now wanting to join organization 120 as a result of organization 120 being modernized, and/or some clients no longer patronizing organization 120 as a result of modernization option. In addition to simulating actual literal cost of purchasing the modernization options, neural network 112 will also simulate secondary costs such as the person-hours being spent integrating the modernization options, an amount of downtime caused to other software applications of the suite of software applications, or the like.

In some examples, controller 110 may cause neural network 112 to simulate how realizing the modernization option will be scheduled into the future in order to calculate the total cost. For example, controller 110 may simulate a plurality of simulations in which personnel of organization 120 provide services of the organization while integrating the modernization option among the suite of software applications at a plurality of dates in the future. Controller 110 may analyze how this results in different costs in different ways, where in some cases there may be more direct cash spent, whereas in other cases there may be less cash but more person-hours, etc. Controller 110 may then identify the total cost of one identified simulation as being below a cost threshold (where other simulations of the plurality of simulations had a cost above the cost threshold), in response to which controller 110 may identify that simulation as the option to pursue. In some examples, controller 110 may schedule the execution of another modernization option of another software application of the suite of software applications at a date prior to the identified date, in order to keep costs at desired levels across a period of time (e.g., spreading out costs across numerous quarters of a fiscal year, rather than bunching them into a single quarter).

As described above, controller 110 may include or be part of a computing device that includes a processor configured to execute instructions stored on a memory to execute the techniques described herein. For example, FIG. 3 is a conceptual box diagram of a computer 101 that can host controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Computing environment 300 contains an example of an environment for the execution of at least some of the computer code involved in performing the inventive methods, such as software application modernization analysis techniques 399. In addition to software application modernization analysis techniques 399, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and software application modernization analysis techniques 399, as identified above), peripheral device set 314 (including user interface (UI) device set 323, storage 324, and Internet of Things (IOT) sensor set 325), and network module 315. Remote server 104 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in software application modernization analysis techniques 399 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in software application modernization analysis techniques 399 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

In addition to software application modernization analysis techniques 399, in some examples gathered or predetermined data or techniques or the like as used by processor set 310 to manage software application modernization analysis is stored on computer 301. For example, persistent storage 313 may include information described above that is gathered from environment 100. Specifically, memory 313 may include some or all data gathered from agents 126, and/or persistent storage may include some or all data of databases 130.

Further, persistent storage 313 may include threshold and preference data. Threshold and preference data may include thresholds that define a manner in which controller 110 is to manage the analysis of software application modernization. For example, the threshold and preference data may include thresholds at which controller 110 executes various tasks as described above, such as user-provided thresholds. This might include where controller 110 is configured to only recommend specific modernization options in response to a calculated cost being below a user-defined cost threshold. Alternatively, or additionally, in some examples controller 110 may be configured to autonomously realize a modernization option where certain thresholds are met. For example, where controller 110 determines that a cost of a modernization option is below a threshold and also that a performance improvement of the modernization option is above a threshold, controller may autonomously realize that modernization option. This may include controller 110 automatically buying new software functionality, scheduling the update for a certain time, reserving some people to integrate/maintain the new software functionality, alerting relevant parties, or the like.

Persistent storage 313 may further include machine learning techniques that controller 110 may use to improve a process of analyzing and/or realizing software modernity options as described herein over time. Machine learning techniques can comprise algorithms or models that are generated by performing supervised, unsupervised, or semi-supervised training on a dataset, and subsequently applying the generated algorithm or model to manage software modernization analysis. Using these machine learning techniques, controller 110 may improve an ability to detect software functionality that could use modernization, identify when a modernization option would improve performance of the software functionality, calculate a true total cost of realizing this modernization option, and/or automatically realizing this modernization option when certain thresholds are met.

Machine learning techniques can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Specifically, machine learning techniques can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

What is claimed is:

1. A computer-implemented method comprising:
analyzing how a software application has performed across numerous dimensions using historical data regarding the software application for an organization;
comparing the performance of the software application to a plurality of modernization options;
identifying a modernization option that is determined to perform better than the software application in at least one of the numerous dimensions; and
calculating a total cost to the organization for realizing the modernization option by a simulation of personnel of the organization providing services of the organization while integrating the modernization option among a suite of software applications.

2. The computer-implemented method of claim 1, wherein the simulation uses data regarding the services and the personnel using a plurality of computing agents reporting real-time data at a plurality of remote computing devices.

3. The computer-implemented method of claim 1, wherein the modernization option includes upgrading one module of the software application.

4. The computer-implemented method of claim 1, wherein the modernization option includes purchasing a different software application.

5. The computer-implemented method of claim 1, wherein the simulation simulates an amount of downtime caused to other software applications of the suite of software applications.

6. The computer-implemented method of claim 1, wherein the calculating the total cost to the organization for realizing the modernization option by the simulation includes:
executing a plurality of simulations in which the personnel of the organization providing services of the organization integrating the modernization option among the suite of software applications at a plurality of dates in the future, wherein the simulation is one of the plurality of simulations and wherein the simulation includes the modernization option being scheduled at an identified date of the plurality of dates; and
identifying the total cost of the simulation as being below a cost threshold, wherein other simulations of the plurality of simulations had a cost above the cost threshold.

7. The computer-implemented method of claim 6, further comprising scheduling executing another modernization option of another software application of the suite of software applications at date prior to the identified date.

8. A system comprising:
a processor; and
a memory in communication with the processor, the memory containing instructions that, when executed by the processor, cause the processor to:
analyze how a software application has performed across numerous dimensions using historical data regarding the software application for an organization;
compare the performance of the software application to a plurality of modernization options;
identify a modernization option that is determined to perform better than the software application in at least one of the numerous dimensions; and
calculate a total cost to the organization for realizing the modernization option by a simulation of personnel of the organization providing services of the organization while integrating the modernization option among a suite of software applications.

9. The system of claim 8, wherein the simulation uses data regarding the services and the personnel using a plurality of computing agents reporting real-time data at a plurality of remote computing devices.

10. The system of claim 8, wherein the modernization option includes upgrading one module of the software application.

11. The system of claim 8, wherein the modernization option includes purchasing a different software application.

12. The system of claim 8, wherein the simulation simulates an amount of downtime caused to other software applications of the suite of software applications.

13. The system of claim 8, wherein the calculating the total cost to the organization for realizing the modernization option by the simulation includes:
executing a plurality of simulations in which the personnel of the organization providing services of the organization integrating the modernization option among the suite of software applications at a plurality of dates in the future, wherein the simulation is one of the plurality of simulations and wherein the simulation includes the modernization option being scheduled at an identified date of the plurality of dates; and
identifying the total cost of the simulation as being below a cost threshold, wherein other simulations of the plurality of simulations had a cost above the cost threshold.

14. The system of claim 13, the memory containing additional instructions that, when executed by the processor, cause the processor to schedule executing another modernization option of another software application of the suite of software applications at date prior to the identified date.

15. A computer program product, the computer program product comprising a computer readable storage medium having program instructions embodied therewith, the program instructions executable by a computer to cause the computer to:
analyze how a software application has performed across numerous dimensions using historical data regarding the software application for an organization;
compare the performance of the software application to a plurality of modernization options;
identify a modernization option that is determined to perform better than the software application in at least one of the numerous dimensions; and
calculate a total cost to the organization for realizing the modernization option by a simulation of personnel of the organization providing services of the organization while integrating the modernization option among a suite of software applications.

16. The computer program product of claim 15, wherein the simulation uses data regarding the services and the personnel using a plurality of computing agents reporting real-time data at a plurality of remote computing devices.

17. The computer program product of claim 15, wherein the modernization option includes upgrading one module of the software application.

18. The computer program product of claim 15, wherein the modernization option includes purchasing a different software application.

19. The computer program product of claim 15, wherein the simulation simulates an amount of downtime caused to other software applications of the suite of software applications.

20. The computer program product of claim 15, wherein:
the calculating the total cost to the organization for realizing the modernization option by the simulation includes:
executing a plurality of simulations in which the personnel of the organization providing services of the organization integrating the modernization option among the suite of software applications at a plurality of dates in the future, wherein the simulation is one of the plurality of simulations and wherein the simulation includes the modernization option being scheduled at an identified date of the plurality of dates; and
identifying the total cost of the simulation as being below a cost threshold, wherein other simulations of the plurality of simulations had a cost above the cost threshold; and
the computer readable storage medium containing additional program instructions that, when executed by the computer, cause the computer to schedule executing another modernization option of another software application of the suite of software applications at date prior to the identified date.
